(19) United States
(12) Patent Application Publication
(10) Pub. No.: US 2013/0159903 A1
(43) Pub. Date: Jun. 20, 2013

(54) METHOD OF DISPLAYING GRAPHIC USER INTERFACE USING TIME DIFFERENCE AND TERMINAL SUPPORTING THE SAME

(71) Applicant: SAMSUNG ELECTRONICS CO., LTD., Gyeonggi-do (KR)

(72) Inventors: Seockhyun YU, Seoul (KR); Ho KIM, Seoul (KR); Hyungjung KIM, Seoul (KR); Donghwan BAE, Seoul (KR)

(73) Assignee: SAMSUNG ELECTRONICS CO., LTD., Gyeonggi-do (KR)

(21) Appl. No.: 13/707,888

(22) Filed: Dec. 7, 2012

(30) Foreign Application Priority Data
Dec. 15, 2011 (KR) 10-2011-0135348

(51) Int. Cl. G06F 3/0481

(52) U.S. Cl. CPC G06F 3/0481
USPC 715/765

(57) ABSTRACT

A method for displaying a graphic user interface is provided. The method involves receiving an input command, such as a selection of an item on a screen, and in response, items currently arranged or to be arranged within one screen are classified into a specific item and one or more other items. The specific item is then displayed in a temporally different manner than the one or more other items.

### CLAIM OF PRIORITY

This application claims the benefit under 35 U.S.C. §119(a) of a Korean patent application filed on Dec. 15, 2011 in the Korean Intellectual Property Office and assigned Serial No. 10-2011-0135348, the entire disclosure of which is hereby incorporated by reference.

### BACKGROUND

1. Technical Field

The present disclosure relates generally to image display management in electronic devices such as portable terminals, and more particularly to a method of displaying a graphic user interface in a portable terminal.

2. Description of the Related Art

With recent development of semiconductor technologies and information communication technologies, various integrated functions have been added to electronic devices. Further, electronic devices provide a graphic user interface for user access to such functions. Each function is indicated by items that are displayed as part of a screen.

Further, a user can use a preset function through a screen that is converted when a specific item is selected in the state where items are listed. While the screen is converted, the user may desire to check the selected item in order to check whether the selection is correctly executed. However, the existing electronic devices do not distinguish items selected by the user and other items in the display while the screen is converted. As such, a user may be unable to properly distinguish desired items, which is inconvenient and may cause erroneous operations.

### SUMMARY

Disclosed are a method of displaying a graphic user interface and a terminal supporting the same, in which user can distinguish a specific item from other items by displaying items with time difference.

In accordance with an aspect of the present invention, a method for displaying a graphic user interface involves receiving an input command, such as a selection of an item on a screen. In response, items currently arranged or to be arranged within one screen are classified into a specific item and one or more other items. The specific item is then displayed in a temporally different manner than the one or more other items.

In accordance with another aspect of the present invention, a terminal for displaying a graphic user interface includes: a display unit that displays a graphic user interface; and a controller configured to receive an input command, and responsive thereto, to classify items currently arranged or to be arranged within one screen into a specific item and one or more items, and to display the specific item in a temporally different manner than the one or more other items

### BRIEF DESCRIPTION OF THE DRAWINGS

The above features and advantages of the present invention will be more apparent from the following detailed description in conjunction with the accompanying drawings, in which:

FIG. 1 is a block diagram illustrating internal configuration of a terminal according to an exemplary embodiment of the present invention;

FIG. 2 is a block diagram schematically illustrating an exemplary configuration of a controller of FIG. 1;

FIG. 3 is a flowchart illustrating a process of displaying a graphic user interface according to an exemplary embodiment of the present invention; and

FIGS. 4 to 8 are screen examples illustrating items displayed with time difference according to various exemplary embodiments of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is to be understood that the singular forms “a”, “an” and “the” include pural referents unless the context clearly dictates otherwise. Thus, for example, reference to “a component surface” includes reference to one or more of such surfaces.

Embodiments described hereinafter relate to a method of displaying a graphic user interface (GUI) and a terminal supporting the same which enable a user to distinguish a specific item from other items by temporally displaying the specific item or the other items differently when displaying a graphic user interface. To this end, an input command such as a user selection of the specific item in a list is received. In response, items currently arranged or to be arranged within one screen are classified into the specific item and one or more other items. The specific item is then displayed in a temporally different manner than the other items, thereby facilitating visualization of the user's selection, allowing the user to more easily recognize if an erroneous selection is made. Herein, the term “item” refers to an image component displayed as part of a GUI, such as an icon, a thumbnail, a list or menu item, etc. A “screen” generally refers to images displayed on a display, but can also signify, in other contexts, a physical display means such as a touch screen.

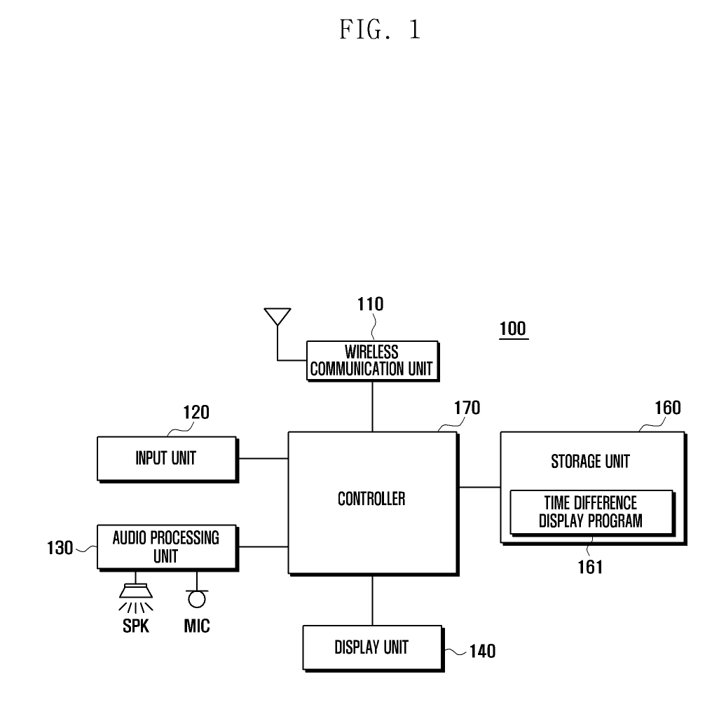

FIG. 1 is a block diagram illustrating an internal configuration of a terminal according to an exemplary embodiment of the present invention. The terminal of the present invention can be implemented in any electronic device if the terminal includes a display unit and provides a GUI. For example, a terminal can be any device which includes a display unit and provides a GUI, including from small devices such as a portable multimedia player (PMP), a digital broadcasting player, a personal digital assistant (PDA), a music file player (e.g., an MP3 player), a portable game terminal, a tablet PC and a smart phone, etc., to home appliances such as a car navigation system, a television, a refrigerator, and a washing machine, etc. For the purpose of explanation, embodiments of the present invention are described below in the context of a smart phone.

Referring to FIG. 1, a terminal 100 according to an exemplary embodiment of the present invention includes a wireless communication unit 110, an input unit 120, an audio processing unit 130, a display unit 140, a storage unit 160, and a controller 170. Each of the components will be explained below.

The wireless communication unit 110 forms a communication channel for a voice call, a communication channel for a video call, and a communication channel for data transmission such as image data and message data (hereinafter, called “data communication channel”), etc. under the control of the controller 170. The wireless communication unit 110 can also receive program code in a download, operation for setting information for a method of displaying an item according to an exemplary embodiment of the present invention through the data communication channel.

The input unit 120 receives the input of various sets of letter information, and transmits signals inputted in connection with setting of various functions and the control of a mobile terminal 100 to the controller 170. The input unit 120 can be a touch screen, e.g., of the capacitive or resistive type, for receiving touch input commands from a user's appendage or a stylus. The input unit 120 can be also formed as one or a combination of a touchpad, a keypad of a general key array, and a keypad of a QWERTY method depending on the provided type of the terminal 100. Further, the input unit 120 can further include a function key such as a direction key, a volume key and a hot key, etc. which are set to perform a certain function. In particular, the input unit 120 of the present invention can generate an input signal which sets a time difference display program 161 to be automatically executed. Further, the input unit 120 can receive a user's input command to generate a signal causing items on the screen to be displayed in a temporally different manner (or requests a screen conversion from a screen that displays items to a screen that executes a certain function, or from a screen that executes a certain function to a screen that displays items).

The audio processing unit 130 includes a speaker (SPK) for replaying audio data transmitted and received during a call, audio data contained in a received message, and audio data according to the replay of an audio file stored in the storage unit 160, etc., and a microphone (MIC) for collecting user's voice or other audio signals during a call. In particular, the audio processing unit 130 of the present invention can output a corresponding sound effect when a specific item is displayed or other items are displayed. Such sound effects may be omitted depending on user's setting.

The display unit 140 displays information inputted by user or information provided to the user according to the use of the mobile terminal 100 in various screens. In particular, the display unit 140 of the present invention displays items corresponding to each of the functions that can be supported in the terminal 100. Further, the display unit 140 displays a specific item and other items at preset time intervals. The detailed description on such a display method will be considered below in more detail. If the input unit 120 is a touch screen, display unit 140 is integrated with the input unit 120.

The storage unit 160 stores at least one application designed to implement a function according an exemplary embodiment of the present invention, user data generated by user, a message transmitted and received with the network, and data according to execution of the application, etc. Such a storage unit 160 can broadly include a program area and a data area.

The program area can store an operating system for booting the terminal and operating the above explained components and downloaded and installed applications, etc. In particular, the program area of the present invention stores a time difference display program 161.

The time difference display program 161 includes routines to support to display items with a time difference according to an exemplary embodiment of the present invention. In particular, the time difference display program 161 according to an exemplary embodiment of the present invention includes a routine for recognizing displayed items, a routine for classifying recognized items into a specific item and other items, and a routine for displaying a specific item and other items with a preset time difference.

A data area is an area where data generated according to the use of the terminal 100 is stored. In particular, a data area of the present invention stores data used or generated while the time difference display program 161 is executed. For example, the data area can store an item image, an item display method, time difference information, item and function mapping information and relative position information between items, etc.

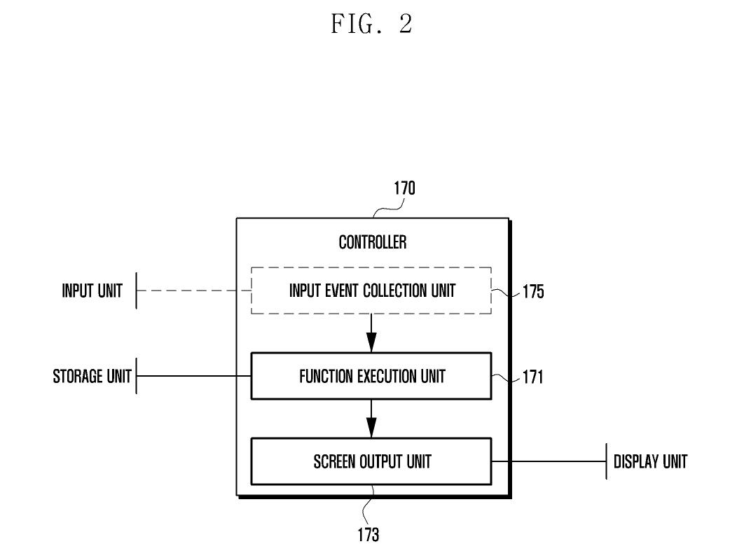

The controller 170 controls general operation of the terminal 100. In particular, the controller 170 of the present invention can control operations of a function that helps a user distinguish a specific item from other items by displaying items with a time difference. For example, when an input command is received, the controller 170 establishes items to be arranged or that are to be arranged within one screen, and checks relative positions between items. Further, the controller 170 classifies items into a specific item and one or more other items. Then the controller 170 controls the display unit 140 to display the specific item and the other items at relative positions with time difference. To this end, the controller 170 can include the configuration as illustrated in FIG. 2.

FIG. 2 is a block diagram schematically illustrating an exemplary embodiment of a controller 170 of FIG. 1. Controller 170 of FIG. 2 includes a function execution unit 171 and a screen output unit 173. Controller 170 can further include an input event collection unit 175.

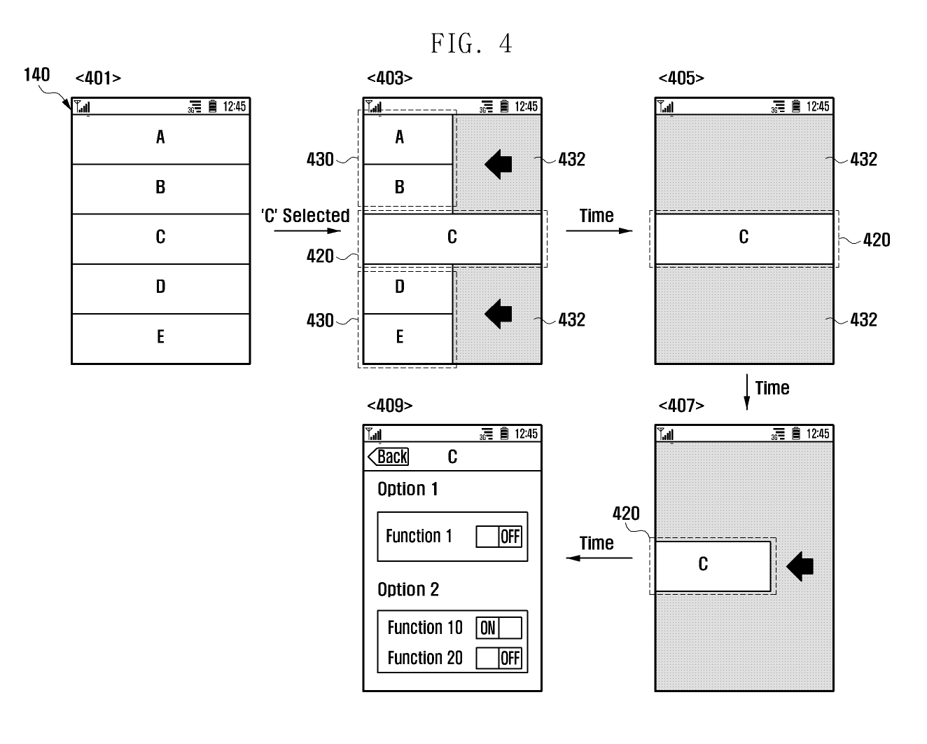

The function execution unit 171 controls overall operation of the terminal 100. In particular, the function execution unit 171 according to an exemplary embodiment of the present invention recognizes items to be arranged or that are arranged within one screen when an input command such as an item selection is received. Further, the function execution unit 171 checks relative positions of items with reference to the storage unit 160. Further, the function execution unit 171 classifies items into a specific item and other items. For example, the function execution unit 171 can classify items according to user's selection received through the input unit 120 or characteristics of a function connected with an item. Further, the function execution unit 171 checks a display method and a display time difference of items. The function execution unit 171 supports various display methods. The display methods will be explained with reference to FIGS. 4 to 8. Further, the function execution unit 171 informs the screen output unit 173 of recognized items and the display method.

The screen output unit 173 generally controls the display unit 140 to display a corresponding execution screen, i.e., a graphic user interface as a user function is executed. In particular, the screen output unit 173 according to an exemplary embodiment of the present invention outputs a specific item and other items with a time difference according to a preset display method under the control of the function execution unit 171. Further, the screen output unit 173 can classify other items so that classified other items can also be outputted at preset time intervals. Various examples of a method of displaying items are illustrated in FIGS. 4 to 8.

Further, the controller 170 can further include an input event collection unit 175. The input event collection unit 175 collects an input event generated in the input unit 120. In particular, the feature of the input event collection unit 175 according to an exemplary embodiment of the present invention is in receiving a user input command that results in a screen change (such input command is referred to herein interchangeably as a “screen conversion request”). For example, the input event collection unit 175 can receive a screen conversion request generated by user's selection of a specific item in a screen where items are displayed, and transmit the received request to the function execution unit 171. As such, the function execution unit 171 can check the selected specific item, and control the display unit 140 to display the selected specific item and other non-selected items with a time difference. Then the function execution unit 171 can control the display unit 140 to display an execution screen of a function connected with the selected specific item. Further, the input event collection unit 175 can receive a screen conversion request for displaying items in a screen of executing a preset function, and transmit the received request to the function execution unit 171. Then the function execution unit 171 can support to display a specific item and other items with a time difference by classifying an item associated with the function execution screen as a certain item.

Heretofore, a terminal of supporting a display of a graphic user interface according to an exemplary embodiment of the present invention has been explained, and hereinafter, a method of displaying a graphic user interface will be described.

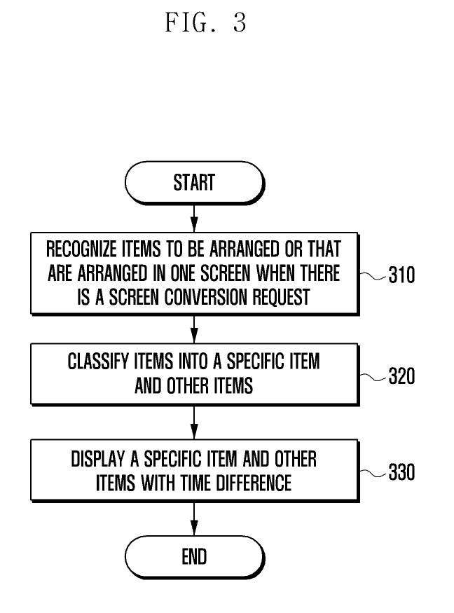

FIG. 3 is a flowchart illustrating a process of displaying a graphic user interface according to an exemplary embodiment of the present invention. The display procedure can be performed when there is an input command (screen conversion request) generated by user's selection of a specific item through the input unit 120 in a screen where items are displayed or when there is a screen conversion request for displaying items in a preset function execution screen. Likewise, the display procedure can be executed by any event for generating a display of items.

Referring to FIG. 3, when there is a screen conversion request, the controller 170 (hereafter, just “the controller”, for brevity) establishes items to be arranged or that are arranged in one screen (310). Then the controller classifies items into a specific item and one or more other items (e.g., the remaining items of the one screen) (320). Here, the controller can classify items into a specific item and items to be displayed as other items (remaining items) using preset criteria. For example, the controller can classify items according to features such as the state of item selection through the input unit 120, the state of execution of a function associated with each item and a function belonging relation.

After classification of items, the method displays a specific item and other items with a time difference (330). For example, the controller controls display of a specific item, and then the display other items after a preset time period. Alternatively, the remaining items are displayed first, and the specific item is displayed after a preset time period. Here, the time difference can be set so that the next item is displayed after waiting until the first displayed items gradually become faint or are gradually moved off the screen (i.e., gradually removed).

Various methods of displaying a specific item and other items can be considered with reference to the screen examples of FIGS. 4 to 8. Displaying items due to a user input command resulting in a screen change is used as a primary example in the explanation of the embodiments. In the examples of FIGS. 4-8, it is assumed that the various operations described and illustrated are performed in the portable terminal of FIG. 1 using the controller 170 as configured in FIG. 2. That is, the controller 170 (hereafter, “the controller” for brevity) controls the various operations illustrated and described, by e.g., executing the time difference display program 161 (hereafter, “the program”).

FIG. 4 is a screen example illustrating a method of displaying a GUI with items displayed in a temporally distinguishable manner according to an exemplary embodiment of the present invention. In this example, an initial screen 401 displayed on the display of display unit 140 is first displayed as a list (e.g., a contact list, music list, menu list, etc.) consisting of selectable items A through E. As illustrated, if a user inputs a command to select item C through the input unit 120, the controller classifies displayed items into item C 420 and other (remaining) items (item A, item B, item D and item E) 430. Here, the controller changes the execution state associated with item C 420 to an activated state. Further, at this time, functions associated with other items 430 are in an inactivated execution state. Hence, the controller can classify items according to the execution state of functions respectively associated with items.

Further, the two types of items 420 and 430 are displayed with a time difference. That is, the two types of items 420 and 430 are temporally displayed in a different manner. For example, referring to screen 403, after item “C” is selected, the remaining items 430 are gradually moved as a group off the screen as time progresses, while the display position of item C remains constant and is optionally emphasized in some manner such as highlighting. As illustrated by the thick arrows of screen 403, other items 430 move to the left all together as if the items were pushed out from the screen. Alternatively, the items move to the right or gradually shrink in size until they disappear. This leaves empty spaces 432 (or a continuously displayed background image in areas 432) which gradually increase in size over time. Then item C 420 is left in the screen while other items 430 have moved off the screen or shrunk to a disappearing state as shown in the screen 405. Further, after other items 430 are displayed as moving, if a preset time period passes, the program can be designed to cause item C 420 to be displayed as moving or shrinking to the left as in the screen 407. In another implementation, the item C 420 is moved after other items 430 become faint or disappear from the screen. Once item C 420 disappears from the screen, the controller controls the display unit 140 to display the execution screen as in the screen of reference numeral 409 by execution of at least one function associated with item C 420. Note that the overall elapsed time between screens 401 and 409 can be pre-set, in the instructions of time difference display program 161, long enough for a user to visually appreciate the relative movement of the items, but short enough to avoid delay inconvenience.

Accordingly, in the example of FIG. 4, item C 420 selected by user is displayed relative to the remaining items 430 with a time difference.

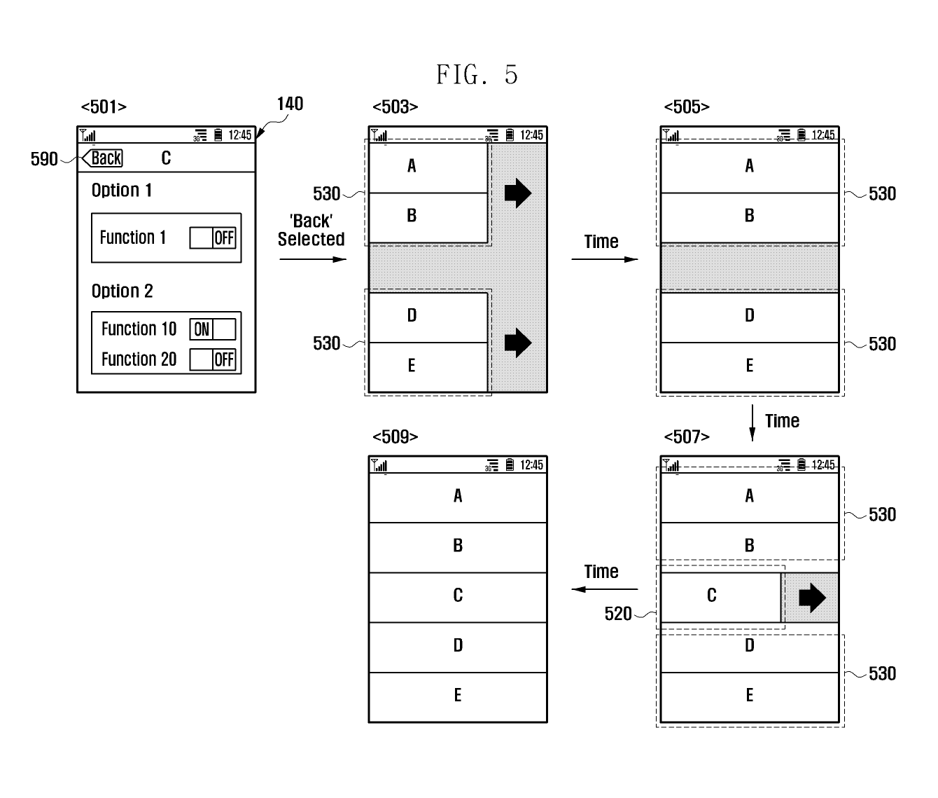

FIG. 5 is a screen example illustrating a method of displaying items with time difference according to another exemplary embodiment of the present invention. The exemplary embodiment explains a method of displaying items with time difference when there is an input command for displaying items in a screen of executing a preset function.

Referring to FIG. 5, an execution screen 501 of a function associated with item C is initially displayed, based on prior input command(s), such as the selection command of FIG. 4. At this point, if a user selects Back button 590 using the input unit 120, the controller determines that there is a screen conversion request for displaying a list to which item C belongs. As such, the controller checks items included in the list, and classifies the items into item C 520 and other (remaining) items 530. Then, item C 520 and remaining items 530 are displayed with time difference. For example, the controller can control the display unit 140 to move remaining items 530 to the right of the screen, as illustrated in screen 503. As such, the screen can exhibit a visual effect as if the remaining items 530 flocked to the screen. By such a movement, as time progresses, the remaining items 530 can be wholly displayed, as illustrated in the screen 505. In the example of screens 503 and 505, item C is not yet displayed, in order to provide a visual effect to the user.

Thereafter, the controller displays item C after a preset time period passes, as in the screen 507. At this time, item C can be gradually displayed in the same manner as was done for items 530 in screens 503 and 505. Further, the controller can set a time difference so that item C begins to be displayed only after the display of the other items is almost or entirely completed. As time progresses further, the display of all items 520 and 530 is completed as in screen 509.

Accordingly, in a condition a plurality of items displayed on one screen which are classified into a specific item and remaining items, embodiments of the present invention can first display the remaining items in a gradual manner, and thereafter display the specific item after a preset time period passes.

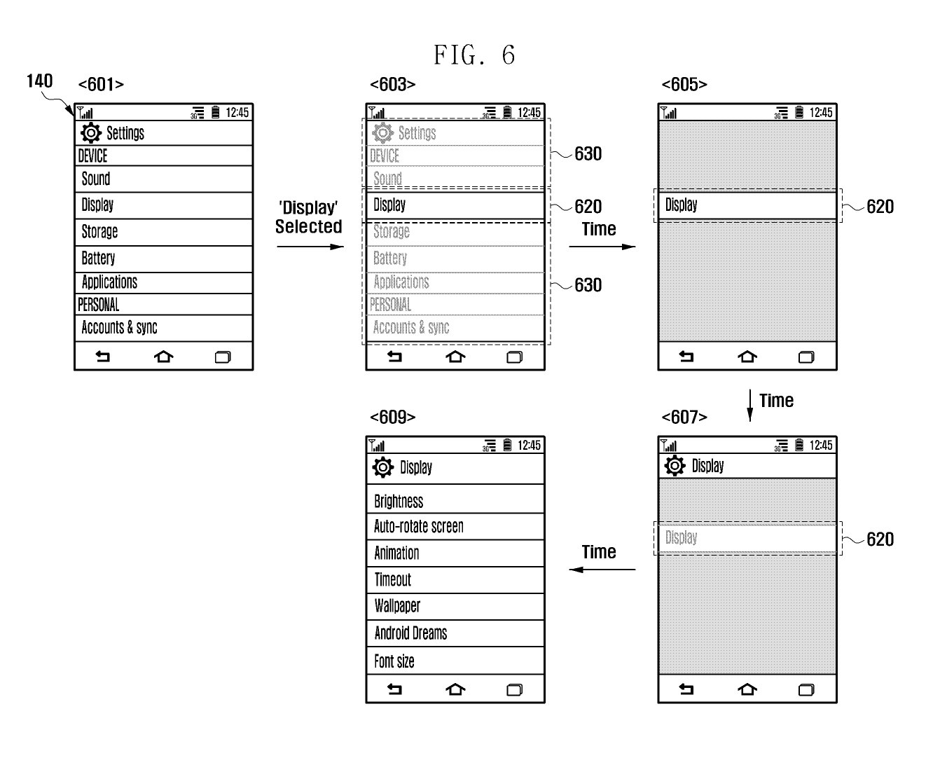

FIG. 6 is a screen example illustrating a method of displaying items with time difference according to a further exemplary embodiment of the present invention. An example of displaying a specific item and other items with time difference by adjusting transparency is explained with reference to FIG. 6.

In this example method, the controller generates a settings menu displayed as an initial screen 601. Further, if item “display” is selected, items are displayed using a display method of adjusting transparency. For example, remaining items 630 (i.e., items except item “Display” 620) become gradually faint by increasing transparency of the items, as illustrated in the screen 603, while the brightness of item 620 remains unchanged. As such, item “Display” 620 can be clearly displayed by itself as shown in the screen 605. Further, as a preset time passes, the controller can control the display unit 140 to exhibit an effect as if item “Display” 620 gradually disappears from the screen by adjusting transparency of item “Display” 620 as another preset time period passes. Further, the controller can control to display the title of an execution screen to be converted when item “Display” 620 gets faint as in the screen of reference numeral 607. The title can be an explanation on a function associated with item “Display” 620. Hence, the user can confirm that the selected item “Display” 620 is, in fact, the item that was correctly selected.

Accordingly, certain embodiments of the present invention can exhibit a fading-out effect by gradually adjusting transparency when displaying items with time difference.

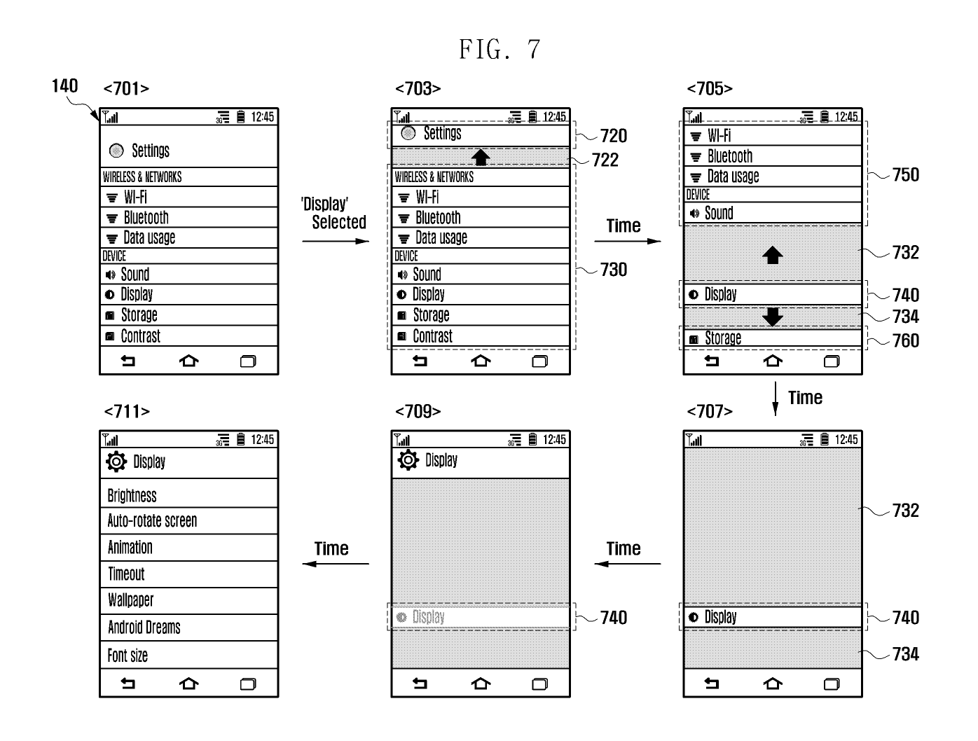

FIG. 7 is a screen example illustrating a method of displaying items with time difference according to still another exemplary embodiment of the present invention. This exemplary embodiment exemplifies a method of classifying items according to a belonging relation (i.e., an association) between items and related functions.

Referring to FIG. 7, the controller controls the display unit 140 to initially display a setting screen 701 of a terminal 100. As will be described further, in the example, when a user selects the item “Display”, the controller determines that the item “Settings” has a belonging relation with the item “Display”. This causes the item “Settings” to be temporarily distinguished visually from the other items, which is followed by distinguishing “Display” from the other items using a time difference display method (temporally displaying “Display” differently from the other items).

More specifically, in conjunction with the generation of screen 701, the controller recognizes that items to be displayed with time difference relative to another apply to all items displayed in the current setting screen. Further, the controller can store in memory relative positions of items and refer to the positions when displaying items with time difference. At this time, if it is determined that item “Display” is selected by a user, the controller can classify items by recognizing the belonging relation between items to be displayed with time difference. For example, the controller can classify items displayed in the screen 701 into “Settings” item 720 and contents items belonging to the title, i.e., other items 730 except “Settings” item 720. Then the controller can control the “Settings” item 720 to be moved upward to be pushed away from the screen, as shown in screen 703. That is, a space 722 is generated between item 720 and the other items 730. Thereafter, the controller can additionally classify items 730 except “Settings” item 720. At this time, the controller can classify items according to the execution state of a function associated with the items 730. Since “Display” item 740 has been selected, the controller can further classify items into “Display” item 740 and other items 750 and 760. Thereafter, the controller can differently set methods of displaying other items 750 and 760 according to relative positions between items 750 and 760 based on the arranged position of “Display” item 740. For example, items 750 positioned at the upper side of “Display” item 740 can be displayed to move upward, and items 760 positioned at the lower side of “Display” item 740 can be displayed to move downward as in the screen of reference numeral 705. This generates vertical spaces 732 and 734 above and below the “Display” item 740, which gradually increase vertically with time. After another preset time, only the Display item 740 remains, as shown in screen 707. The “Display” item 740 can remain the same as in the screen 707. After other items 750 and 760 begin to be displayed as moving, if a preset time passes, the “Display” item 740 is displayed gradually fading out, as shown in the screen 709. The controller thereafter controls to display an execution screen associated with “Display” item 740, as depicted in the screen 711.

Further, a method of classifying items based on the combination of the belonging relation and execution state of a function related with items has been explained above, but in other implementations, the controller can classify items based only on the belonging relation. Further, the controller can control to display such classified items with time difference. For example, the controller can classify items based on the category title and the contents which belong to the title. Therefore, the controller can control to classify items into “Setting” item 720 and other items 730, display first “Setting” item 720 as moving, and then display other items 730 as moving.

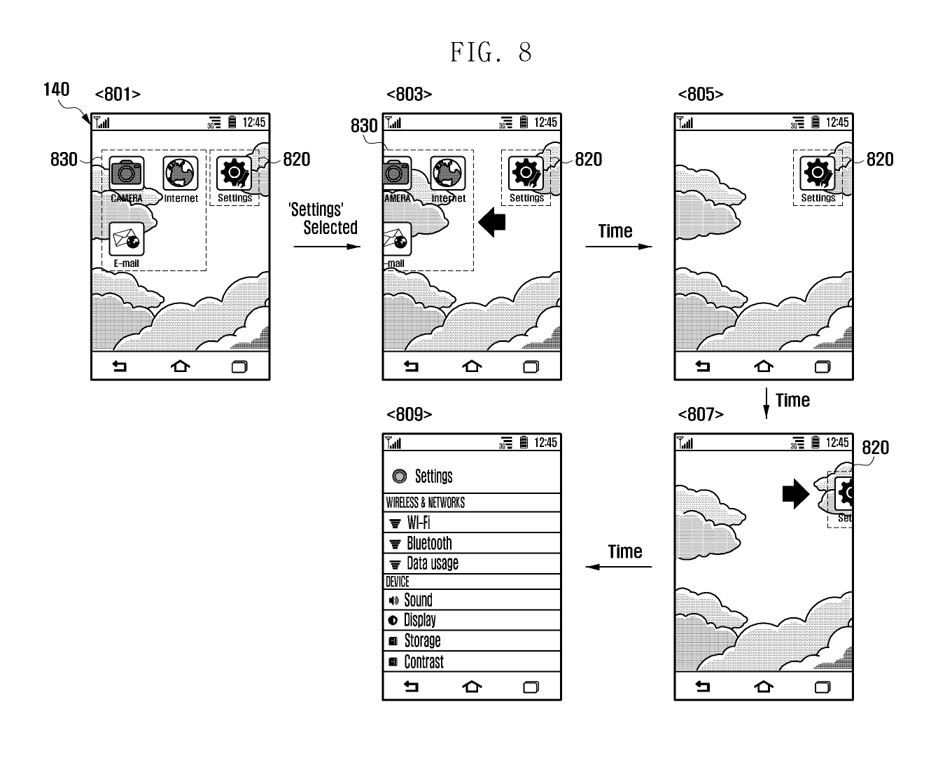

FIG. 8 is a screen example illustrating a method of displaying items with time difference according to yet another exemplary embodiment of the present invention. The exemplary embodiment explains that the present invention can be implemented even in a home screen. In such a case, items can be displayed in icon types.

Referring to FIG. 8, the controller controls to recognize icons of a home screen according to a home screen display request, and display the screen of reference numeral 801. The screen of reference numeral 801 is a home screen consisting of “Camera” icon, “Internet” icon, “Settings” icon and “E-mail” icon. If “Settings” icon 820 is selected, the controller classifies icons 820 and 830 into “Settings” icon 820 and other icons 830. Then the controller controls the display unit 140 to gradually modify the display such classified icons at preset time intervals. For example, the controller controls to leave “Settings” icon 820 in the screen as shown in screen 805 by continuously moving other icons 830 to the left of the screen as illustrated in the screen 803. Further, if it is determined that a preset time period has passed after other icons 803 have started to move, the controller controls to display “Settings” icon 820 as moving to the right as in the screen of 807. After “Settings” icon 802 is pushed out of the screen, the controller 170 controls the display unit 140 to output the execution screen of a function associated with “Settings” icon 820 as in the screen 809.

As explained above, according to a method of displaying a graphic user interface and a terminal supporting the same according to exemplary embodiments of the present invention, the present invention helps user to recognize and check initially displayed items and later displayed items separately by displaying a specific item and other items with time difference. Further, the present invention has an advantage that user can check a selected function in the process of screen conversion by displaying the selected item and non-selected items at a certain time interval when converting the screen due to the selection of a specific item.

The above-described methods implemented via controller 100 according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for displaying a graphic user interface, the method comprising:
receiving an input command;
responsive to the input command, classifying items currently arranged or to be arranged within one screen into a specific item and one or more other items; and
displaying the specific item in a temporally different manner than the one or more other items.

2. The method of claim 1, wherein displaying the specific item in a temporally different manner comprises displaying the specific item and then gradually displaying the other items as time passes, or displaying the other items and then gradually displaying the specific item as time passes.

3. The method of claim 1, wherein displaying the specific item in a temporally different manner comprises gradually dimming, gradually brightening, or gradually moving on or off the screen, the specific item or the other items as time passes.

4. The method of claim 1, wherein classifying items classifies items according to at least one of a selection state of the specific item and the other items, an execution state of a related function, and a belonging relation.

5. The method of claim 4, wherein classifying items classifies items related to the function as the specific item.

6. The method of claim 1, wherein displaying the specific item in a temporally different manner comprises gradually changing an arranged position of the specific item or the other items as time passes.

7. The method of claim 6, wherein displaying the items by changing the arranged position displays the items by moving the arranged position in at least one direction.

8. The method of claim 1, further comprising:
classifying the other items into at least one first other item and at least one second other item if the number of the other items is two or more; and
displaying the at least one first other item and the second other item differently.

9. The method of claim 8, wherein classifying the other items into the at least one first other item and the second other item classifies the items according to a relative position with the specific item and a belonging relation with a function associated with the specific item.

10. The method of claim 8, wherein displaying the at least one first other item and the at least one second other item differently displays the first and second other items differently in at least one of a temporal aspect or a spatial aspect.

11. A terminal displaying a graphic user interface, the terminal comprising:
a display unit that displays a graphic user interface; and
a controller configured to receive an input command, and responsive thereto, to classify items currently arranged or to be arranged within one screen into a specific item and one or more items, and to display the specific item in a temporally different manner than the one or more other items.

12. The terminal of claim 11, wherein the controller controls the display unit to display the specific item and then display the other at least one item after time passes, or to display the other items and then display the specific item after time passes.

13. The terminal of claim 11, wherein the controller controls the display unit to display the other items after time passes until the specific item becomes faint or is removed, or to display the specific item after time passes until the other items become faint.

14. The terminal of claim 11, wherein the controller controls the display unit to display the specific item and the other items with a visual effect.

15. The terminal of claim 14, wherein the visual effect is at least one of a motion as if items are pushed out from the screen, a motion as if items flock to the display unit, an appearing effect and a fading-out effect.

16. The terminal of claim 14, wherein the specific item and the other items exhibit different effects.

17. The terminal of claim 11, further comprising:
an input unit that generates an item selection signal by receiving the input command as a selection of one of the items,
wherein the controller receives the item selection signal from the input unit, and classifies an item corresponding to the item selection signal as the specific item.

18. The terminal of claim 11, wherein the controller recognizes a function associated with each of the items, and classifies items into the specific item and the other items according to a belonging relation between the functions.

19. The terminal of claim 11, wherein the controller classifies the other items into at least one first other item and at least one second other item according to a relative position with the specific item if the number of the other items is two or more, and controls the display unit to move the at least one first other item in a first direction and move the at least one second other item in a second direction.

20. A computer-readable storage medium storing one or more programs comprising instructions which, when executed by an electronic device, cause the device to execute the method according to claim 1.
